(19) United States
(12) Patent Application Publication
(10) Pub. No.: US 2012/0217712 A1
(43) Pub. Date: Aug. 30, 2012

(54) VEHICLE WHEEL AND AXLE SYSTEM

(76) Inventors: Oliver Christoph Ferdinand Kuttner, Charlottesville, VA (US); Ronald Christopher Mathis, Indianapolis, IN (US)

(21) Appl. No.: 13/502,222

(22) PCT Filed: Apr. 20, 2011
(86) PCT No.: PCT/US11/33198

§ 371 Date: Apr. 16, 2012

Related U.S. Application Data
(60) Provisional application No. 61/327,433, filed on Apr. 23, 2010.

(51) Int. Cl. B62D 21/18

(52) U.S. Cl. 280/124.1

(57) ABSTRACT

An axle and wheel system for enhancing the safety of occupants of a vehicle. An axle structure is provided which is engineered to be crushable upon impact. The axle is structurally attached to the chassis of the vehicle and extends beyond the chassis on both sides thereof. Each axle end is attached to a wheel suspension. The portion of the axle extending beyond the chassis is covered by an aerodynamic ally shaped, crushable fairing and each wheel is covered by an aerodynamically shaped, crushable pod.

### CROSS-REFERENCES TO RELATED APPLICATIONS

This application claims priority from U.S. provisional application 61/327,433 filed on Apr. 23, 2010, which is incorporated herein by reference in its entirety.

### TECHNICAL FIELD

The subject invention relates generally to increasing the safety of occupants of a light weight vehicle. More particularly, structures are presented for implementation in such a vehicle which reduce the peak accelerations on vehicle occupants by adding strategically located crushable spaces and by changing the type of impact or mode of engagement between the subject vehicle and another object.

### BACKGROUND OF THE INVENTION

The initial problem in building a very light vehicle results from the fact that it has a mass disadvantage compared to the average car seen on today's streets. The intuitive view on this matter is that added mass, which results in more momentum and energy assuming the same speed, creates an extra level of safety for the occupants in that vehicle. The larger momentum helps to reduce the accelerations seen by its occupants in certain collisions by “bullying” the other vehicles, thereby moving the struck objects out of the way. This innate feeling of added safety that comes with heavier cars is actually a false belief. As a result of their higher mass, SUV's and pickups (some of the heaviest vehicles on the road driven by non commercial drivers) cause more deaths to drivers of other vehicles than cars and minivans do. However a large increase in fuel efficiency is currently obtainable only by constructing a vehicle having low weight and little aerodynamic drag. Such a vehicle must also be designed to overcome the disadvantage accompanying its low mass and to provide protection for its occupants.

The laws of physics are non-negotiable. Reducing the peak accelerations on the occupants of a vehicle can be accomplished both by absorbing energy through crushable space and by changing the type of impact or the mode of engagement that two vehicles or objects have in a collision. It is important to see collapsible space as both crushable structures in the vehicle and cushioning material inside the vehicle. What is needed is a very light vehicle construction which can compete successfully in providing occupant safety with other heavier cars and SUV's on today's roads. This goal can be achieved by providing space for proper energy absorption and/or deflection that is not available in most cars today.

### SUMMARY OF THE INVENTION

The present invention relates to a wheel and axle system for a multi-wheeled vehicle. In one embodiment of a vehicle constructed according to the principles of this invention, the wheels of the vehicle are spaced outside and away from the main body chassis of the vehicle in which occupants reside. The suspension system for each wheel is located at least partially within each wheel. A crushable axle is structurally attached in at least one place to the main body chassis and extends a distance away from the main body chassis where it is attached on one end to an in-wheel suspension system. An aerodynamically shaped, crushable fairing is attached at one end to the main body chassis and covers that part of the axle which extends outside of the main body chassis. An aerodynamically shaped, crushable pod covers each wheel. In one embodiment, a crushable axle is provided which is attached to the suspension within a wheel on one side of the car and runs uninterruptedly to the in-wheel suspension on the other side of the car. In one embodiment, this axle is structurally attached to the main body chassis at two points, one on each side of the vehicle at points near the respective wheels.

### BRIEF DESCRIPTION OF THE DRAWINGS

The foregoing and other objects, aspects and advantages of the invention will be better understood from the following detailed description of the invention with reference to the drawings, in which

FIG. 1 is a frontal perspective view of a very light vehicle embodying the principles of this invention.

FIG. 2 is a rear perspective view of a very light vehicle embodying the principles of this invention.

FIG. 3 is an overhead view of a very light vehicle embodying the principles of this invention.

FIG. 4 is a bottom view of a very light vehicle embodying the principles of this invention.

FIG. 5 is a side view of a very light vehicle embodying the principles of this invention.

FIG. 6 is a perspective view drawn to scale of the tubing structure of a very light vehicle embodying the principles of this invention.

FIG. 7 is an overhead cross sectional view drawn to scale of a very light vehicle embodying the principles of this invention.

FIG. 8 is a cross-sectional overhead view drawn to scale of the front nose of a vehicle constructed according to the principles of this invention.

FIG. 9 is a transparent view drawn to scale of the front crush zone of a vehicle constructed according to the principles of this invention.

FIG. 10 is a transparent view drawn to scale from the rear of a vehicle constructed according to the principles of this invention.

FIG. 11 is a transparent side view drawn to scale of a vehicle constructed according to the principles of this invention.

### DETAILED DESCRIPTION OF THE INVENTION

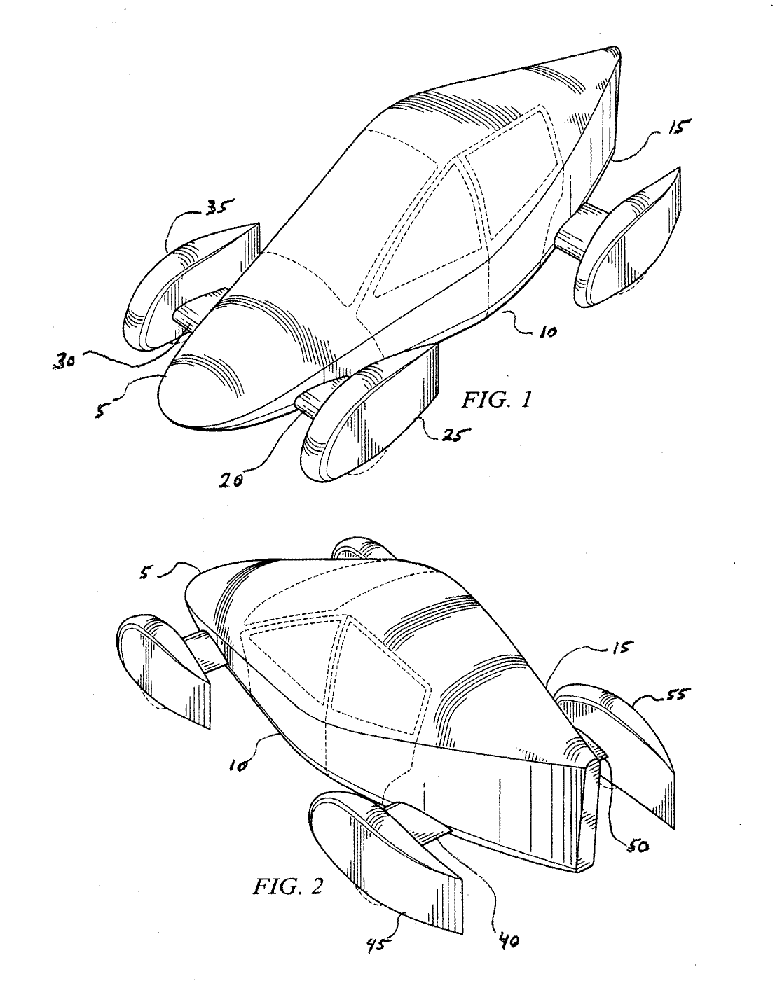

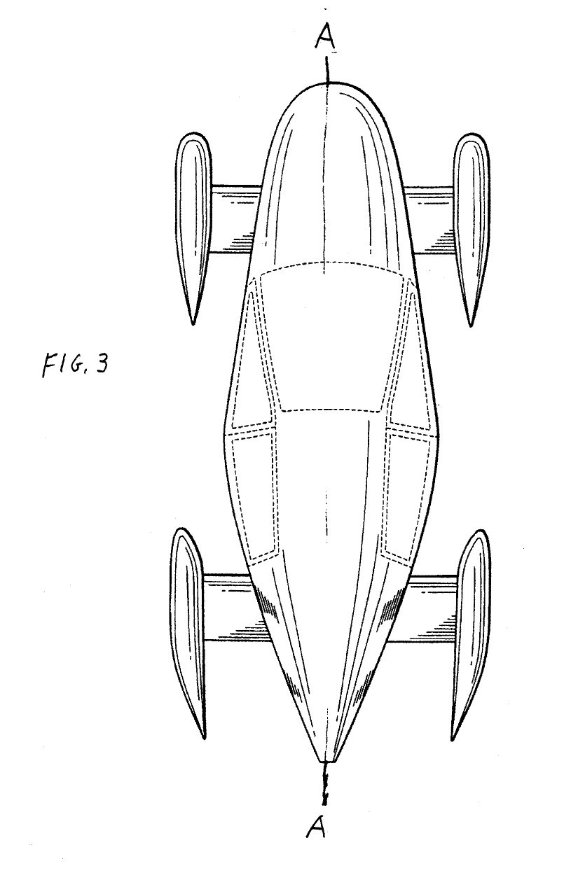

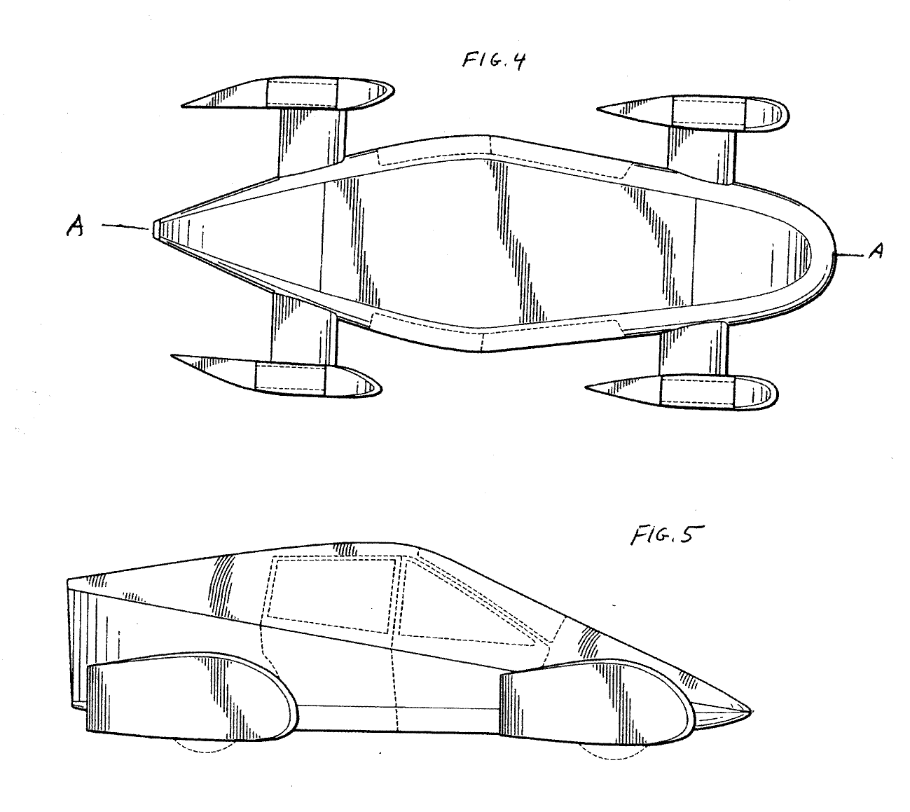

In order to obtain the advantages inherent in a very light vehicle (VLV) while maintaining safety for its occupants, the shape, configuration and construction techniques used in building the vehicle must all be considered. FIG. 1 presents a frontal perspective view of the exterior of a very light vehicle constructed according to this invention. The vehicle is comprised of three interconnected sections: front section 5, middle section 10 and rear section 15. First fairing 20 extends from first front wheel pod 25 to front section 5, while second fairing 30 extends from second front wheel pod 35 to front section 5. Middle section 10 is a passenger area which includes windows and at least one door for entry and exit from the vehicle. As shown in FIG. 2, third fairing 40 connects first rear wheel pod 45 to rear section 15, while fourth fairing 50 connects second rear wheel pod 55 to rear section 15. A wheel is located within each of the wheel pods. The shape of front section 5 has a relatively narrow rounded edge with minimal frontal surface area as compared to other vehicles. This is a very aerodynamic shape which permits airflow to adhere to the car body, thereby reducing form drag. In addition, since the vehicle is symmetric relative to a center plane along a main longitudinal axis, indicated by center line A-A in FIG. 3 and FIG. 4, the small frontal width reduces the forward surface of the car exposed to potential collisions resulting in an increased likelihood that in the event of a collision the impact will be deflected away from the car body in the X and Y axes so long as the collision occurs to one side or the other of the vehicle centerline. In such a collision, the front axle and the front wheel pod which is struck are designed to be break-away, sacrificial structural members so that the velocity of the impact is reduced concurrently reducing the peak force experienced by the vehicle occupant. Further, as shown in FIG. 3, the overall configuration of a VLV embodying the principles of this invention has a generally teardrop shape when viewed from overhead. This shape has been found to have very favorable aerodynamic characteristics. Moreover, as shown in FIG. 5, since the surface of front section 5 is constructed so as to sweep towards the rear of the vehicle, forces involved in a collision would also be deflected away from the vehicle in a vertical Z axis. As a result of these features, crash pulse, which is a standard used in measuring crash severity, is reduced as is the peak acceleration or accelerations of vehicle occupants.

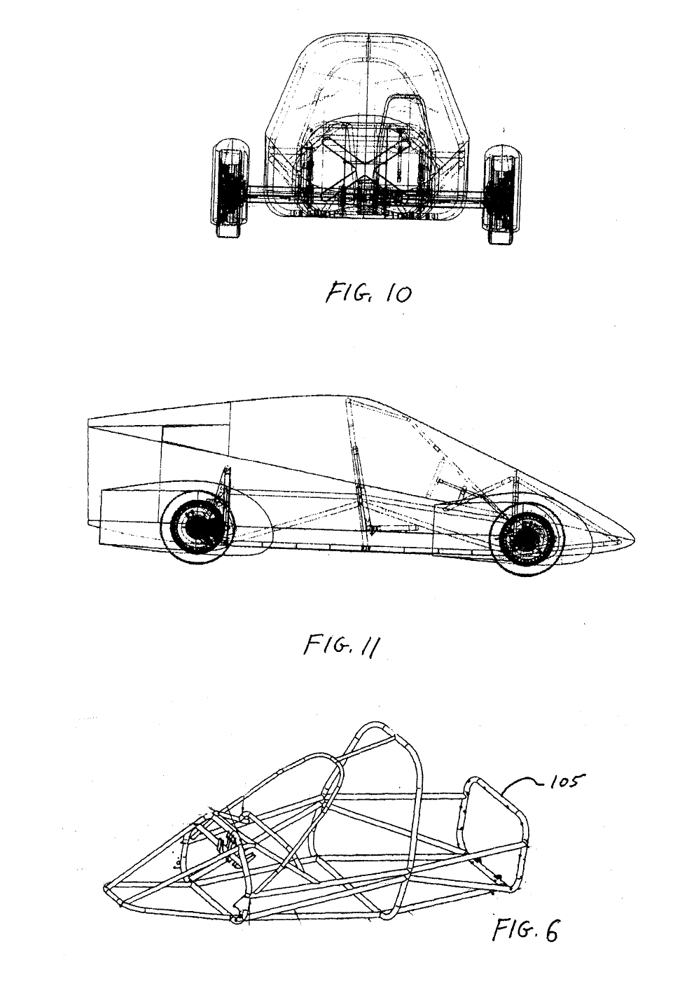

Front section 5 also incorporates a crush zone as a further safety enhancement. FIG. 6 presents a perspective view of the tubular frame structure 105 of a vehicle embodying the principles of this invention. In any frontal impact, safety is enhanced not only by deflection of impact forces but also by a construction which reduces the accelerations experienced by vehicle occupants. The front tubing structure of the very light vehicle is comprised of a lower hoop attaching to the bottom of the front bulkhead, and supported by two tubes connecting the front of the hoop to the top of the front bulkhead. Due to the front frame geometry, a front impact would likely bend the lower hoop upwards, putting the upper support tubing in compression, leading to the tubes buckling at planned failure initiators. This tubing provides an inner protective shield for vehicle occupants. The front structural tubing is supplemented by a body made from a stressed material which can be a composite, steel, aluminum, plastic or a resin-reinforced paper mache or any other material which is capable of maintaining the stiffness of the front nose. This aids with energy absorption in several ways. The first benefit is that the body assists in energy absorption due to the addition of structural ridges and reinforced sections to the body, as desired. The second benefit is that the body is spaced away from the tubing and the inner shell of the body. The inner shell may be attached to the outer shell by energy absorbing foam or blocks at the mating points or, alternatively, some or all of the space between the inner shell and the outer shell may be substantially filled with an energy absorbing material such as a foam or multiple energy absorptive blocks. Use of such energy absorbing material would be especially beneficial when placed in front section 5. The body and the respective energy absorbing material provides a middle protective shield for vehicle occupants.

One of the peak accelerations a vehicle driver and occupants experience in a crash comes from the front wheels collapsing into and getting stuck against a non-collapsible rocker panel, transferring a large shock to the passenger compartment. As shown in FIG. 1 and FIG. 2, the wheels of the very light vehicle of this invention are placed outside of and away from the main body chassis, deviating significantly from the standard automotive design and thereby substantially eliminating this hazardous aspect of previous vehicle designs. In addition, the disclosed wheel/wheel pod configuration provides nonhazardous crushable space outside of middle section 10 and enables the placement of crushable materials between the wheels and the middle section 10 of the disclosed vehicle. There are at least 12 inches between each front wheel pod and the front bulkhead. At least this amount of space is required to avoid production of drag and other counterproductive forces resulting from an unnecessarily large acceleration of air through an otherwise too narrow gap. On the other hand, care must be taken not to make the vehicle too wide. Consequently, the inner surface of each wheel pod is located close to the outside face of the wheel contained therein. The space between each pod and the body of the vehicle will typically contain a crushable aluminum tube axle and a crushable front fairing about 12 inches wide and about 12 inches long covering the axle which can be filled with energy absorbing foam. The distance between each rear wheel pod and the rear bulkhead is somewhat larger in order to have the front and rear wheels follow the same track. All of these features combined provide vehicle occupants with unprecedented protection from the wheel in both front and side impact crashes as further described below.

As disclosed above, each of the wheels is enclosed by a wheel pod. This is both a legal and an aerodynamic requirement due to the displacement of the wheels from the fuselage of the vehicle. Legally, the pods can be quite small in size, but the need for aerodynamic efficiency mandates a smooth and rounded front and a long trailing edge meeting at a point in the rear. Since the combined length of the wheel pods on each side of the VLV is less than that of the vehicle's main body, there is a tendency for the main vehicle body to dominate airflow direction. Consequently, although each pod approximates a teardrop shape, the rear pods 45 and 55 terminate with an inward curvature in order to counteract that tendency. To accomplish this design, pods 25, 35, 45 and 55 are approximately 4 feet in length and create an outer protective barrier along the sides of the vehicle. They extend along at least 60% of each side of the vehicle leaving no more than a 4-foot gap between the two of them on each side of the vehicle. This outer protective shield plays an important part in side impact energy absorption and deflection, as discussed below. Between 40% and 50% of the space inside of the pod is empty, allowing it to be filled with a crushable foam to aid in energy absorption if the wheel pod were to be crushed between the passenger compartment and another object. In an alternative embodiment, the front and rear fairings could be dispensed with and the pods could be located directly adjacent the vehicle body.

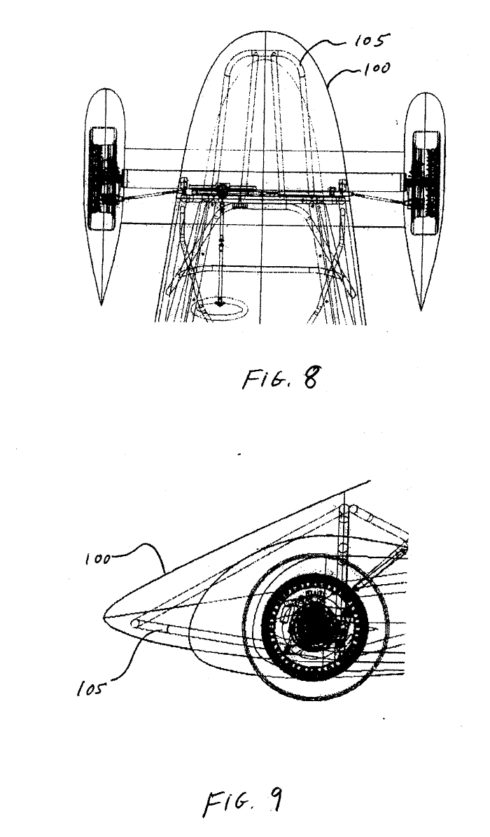

As shown in FIG. 9, front axle 70 runs from first front wheel suspension 75 through first fairing 20, front section 5 and second fairing 30, respectively, to second front wheel suspension 80. Rear axle 85 runs from first rear wheel suspension 90 through third fairing 40, rear section 15 and fourth fairing 50, respectively, to second rear wheel suspension 95. Each axle may either be a one- or a multi-piece unit. Each wheel suspension is rigidly mounted to a respective axle and is configured to suspend a freely rotating wheel bearing relative to the end portion of that axle. A wheel is separately mounted to each of the wheel suspensions. The axles may be constructed from aluminum or any other material which is both rigid enough to function as an axle but also lends itself to a break-away configuration and are generally circular, each having a diameter of about 4 inches. The required dimensions of any material used as an axle are easily calculable in a known manner from Euler's Buckling Load formula. First, the moment of area is calculated from the known inner and outer dimensions of the axle. Then, the Euler load is calculated based on the modulus of elasticity for the material from which the axle is made, the moment of area, the known length of the axle and a constant representing the column effective length factor. In order to obtain crushability, the Euler load should substantially exceed the axial compression limit of the material calculated from the yield stress divided by the area of the material. Thus, in the instant case for an aluminum axle which is 12 inches long from the point of attachment to the chassis to the suspension, the diameter of a tubular aluminum axle is 4 inches, while the thickness of the material is 0.049 inches. The Euler Load in this case is about eight times the axial compression limit thereby producing the desirable crushability. The same calculations can be applied to any other material desired to be used as an axle. When paired with wheel pods 25, 35, 45 and 55, this configuration creates an impact deflection shield along the latitudinal periphery of the vehicle and, in addition, provides exceptional energy absorption qualities. The axles are structural members, connecting the wheels and pods to the chassis. Less than 40% of the vehicle chassis, comprised of front section 5, middle section 10 and rear section 15, is laterally exposed. Consequently, in the event of a side impact collision at least one of the wheels or pods would likely be the initial point of contact. The initial contact would create a force to be transmitted into the axle and eventually to the vehicle. The resulting collision force would either start moving the VLV away from the impacting vehicle or object, thereby deflecting the VLV out of harm's way, or, due to the energy absorbing features described above, reduce the difference in velocities between the VLV and the impacting vehicle or object through deceleration by the time the impacting vehicle or object reaches the main chassis structure of the VLV.

If the latter scenario is the case, the object will most likely have had to pass through the wheel-pods, fairings, and axle(s) to reach the chassis. In this event, the axle will be placed in compression. The material from which the axle is constructed must be one which is likely to crush when exposed to compressive forces in a side impact. In addition failure initiators may be properly placed in each axle to ensure the mode of failure absorbs as much energy as possible. Alternatively, a different crushable structure such as carbon, steel or a developed casting may be used so long the out-board suspension design provides the ability to have a crushable axle for occupant protection.

Note also that frame 105 is generally diamond-shaped, having a wide middle section and a relatively small front and rear bulkhead. This structure provides extra occupant protection by collapsing in a way that generates increased space for the occupants of middle section 10. In certain heavy impacts, the engagement of frame 105 in the collision event cannot be avoided. In a front impact, the diamond shape would get shorter in length, but wider in middle section 10 that contains vehicle occupants. In the case of a side impact, middle section 10 would get longer as the shape was forced narrower, continuing to provide extra space for vehicle occupants.

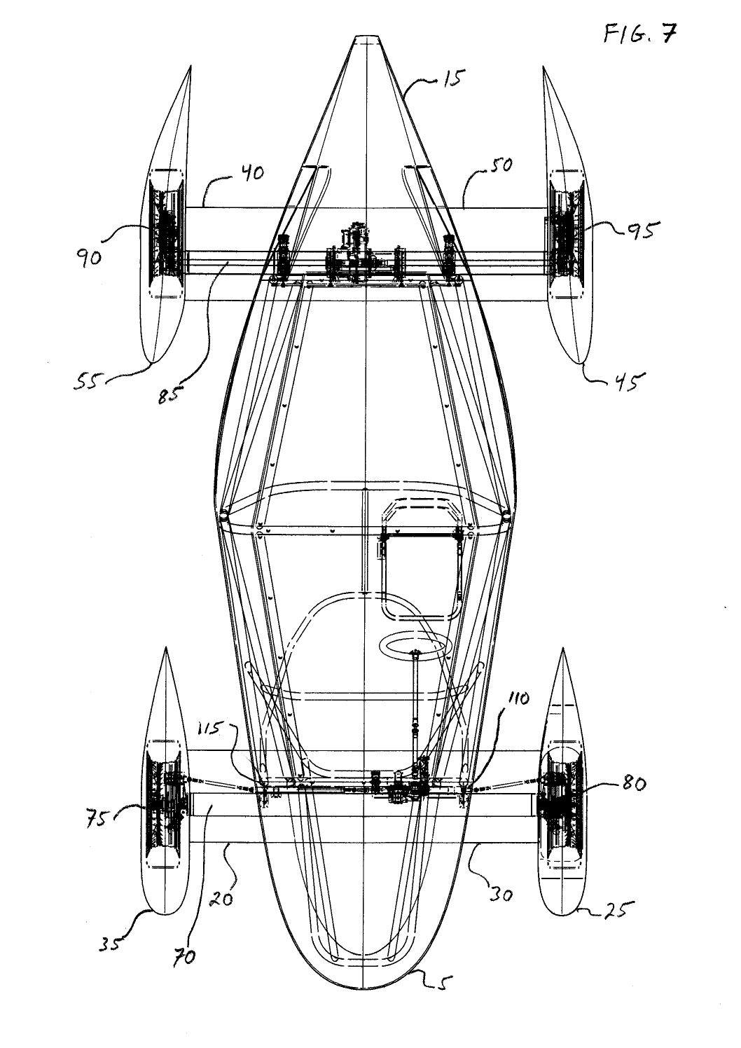

FIGS. 7 through 11 present other informative views of the structure of an embodiment of a VLV constructed according to the principles of this invention. FIG. 7 is an overhead cross sectional view of a very light vehicle embodying the principles of this invention. It shows the location of the axles which play an important part in energy absorption thereby increasing the safety of the vehicle. FIG. 8 shows a cross-sectional overhead view of the front nose of a vehicle constructed according to the principles of this invention. Front axle 70 is structurally attached to the chassis at points 110 and 115. The nose shape favors deflection rather than engagement during a collision. FIG. 9 provides a transparent view of the front crush zone of a vehicle constructed according to the principles of this invention. FIG. 10 is a transparent view from the rear of a vehicle constructed according to the principles of this invention. This figure shows that the wheels are clear of any rocker panel, thereby helping to increase occupant safety. FIG. 11 is a transparent side view of a vehicle constructed according to the principles of this invention. It shows that the wheel pods, 25, 35, 45 and 55, cover over 60% of the side of the vehicle, thereby improving safety in the event of a side impact.

Further protection is provided by the use of a stressed honeycomb floor in middle section 10. The floor may be made from aluminum or any other material which can both support occupants within the vehicle and still collapse in a predictable fashion. As frame 105 experiences forces from an impact, those same forces would be transferred into the floor structure, trying to alter its shape as well. The floor adds stiffness to the chassis for relatively small forces, and will fail in a progressively resistant manner during a more substantial impact due to its honeycomb internal structure.

By constructing the VLV from a low density material, an extremely light-weight and low mass vehicle is obtained which results in several unanticipated advantages. Contrary to expectations, low mass actually enhances the safety aspects of the vehicle since, in a wide variety of crashes including for example other vehicles, pedestrians and bicycles, the VLV produces smaller internal forces on its own components than a larger, heavier vehicle would produce. These reduced forces become advantageous when the VLV strikes a stationary object, another light obstacle, or a pedestrian. The likely outcome is less damage to the object and the VLV, while the chance of survival for a pedestrian who has been struck would greatly increase. Furthermore, the lighter weight of the VLV results in a vehicle that has superior handling and braking making it an all-around easier car to drive. Consequently, the driver has more control and is able to avoid many potential crashes.

While preferred embodiments of the present invention have been illustrated and described, it will be understood by those skilled in the art that various changes and modifications may be made, and equivalents may be substituted for elements thereof without departing from the true scope of the present invention. Thus, the configuration principles disclosed herein may be equally applied to larger freight-carrying vehicles such as trucks and to smaller passenger vehicles. In addition, many modifications may be made to adapt the teaching of the present invention to a particular situation without departing from its central scope. Therefore it is intended that the present invention not be limited to the particular embodiments disclosed herein.

What is claimed is:

1. A wheel and axle system for a multi-wheeled vehicle having a main body chassis comprising:
at least two wheels located outside of and away from the chassis, each on an opposing side of the chassis;
a suspension system for each wheel; and
at least one crushable axle structurally mounted in at least one location to the chassis and attached in at least one other location to at least one of said suspensions, each said axle extending beyond the chassis edge to said suspension.

2. The wheel and axle system of claim 1, further comprising:
an aerodynamically shaped, crushable fairing for each said wheel, each said fairing attached on one end to the body or chassis, said fairing completely covering that part of said axle extending beyond the chassis edge; and
an aerodynamically shaped, crushable pod covering each said wheel.

3. The wheel and axle system of claim 2 wherein the remainder of the space within each said fairing not occupied by said axle is filled with crushable, energy absorbing material.

4. The wheel and axle system of claim 2 wherein the remainder of the space within each said pod not occupied by one of said wheels is filled with crushable, energy absorbing material while still allowing the wheel to rotate freely without impeding any said suspension.

5. The wheel and axle system of claim 2 wherein each said pod is located a known distance away from the main body chassis.

6. The wheel and axle system of claim 1 wherein said axle is a single or multi-piece unit connected on one end to one said suspension on one side of the vehicle and on the other end to another said suspension on the opposing side of the vehicle, said axle being structurally mounted to the chassis at two locations, one on each side of the vehicle.

7. The wheel and axle system of claim 5 wherein the known distance is at least twelve inches.

8. The wheel and axle system of claim 5 wherein each fairing has a length equal to the known distance.

9. The wheel and axle system of claim 1 wherein each said axle is made from crushable aluminum.

10. The wheel and axle system of claim 1 wherein each axle has a generally circular cross-sectional shape and is generally tubular along its length.

11. The wheel and axle system of claim 1 wherein each said pod is approximately four feet long.

12. The wheel and axle system of claim 1 wherein each said axle is constructed with failure initiators.

13. The wheel and axle system of claim 1 wherein each said suspension system is at least partly mounted within one of said wheels.

14. The wheel and axle system of claim 1 wherein each said axle is hollow.
